(19) United States
(12) Patent Application Publication
(10) Pub. No.: US 2002/0147627 A1
(43) Pub. Date: Oct. 10, 2002

(54) Creative idea generation process

(76) Inventors: Marcia Roosevelt, New York, NY (US); Mark Payne, New York, NY (US)

Correspondence Address: NOTARO AND MICHALOS, 100 DUTCH HILL ROAD, SUITE 110, ORANGEBURG, NY, 10962-2100, US

(21) Appl. No.: 09/782,864

(22) Filed: Feb. 14, 2001

(51) Int. Cl. G06F 17/60

(52) U.S. Cl. 705/10

(57) ABSTRACT

A method for developing a conceptual design for a product or service involves defining conceptual design project goals and parameters and then creating a project team representing several diverse types of intelligences. The team is directed to generate multi-faceted ideas embodying brand, product or service, and marketing communications concepts in accordance with the project goals and parameters. The diverse intelligences represented on the team results in a greater variety, freshness and depth of ideas generated by the team for use in marketing and advertising the product or service. Better quality and more innovative concepts can be developed faster and more completely that have broader appeal to diverse intelligences than by using conventional methods.

### FIELD AND BACKGROUND OF THE INVENTION

The present invention relates generally to the field of marketing and advertising and in particular to a new and useful method for conducting a conceptual design process requiring creative idea generation.

In conventional marketing practice, conceptual design, or concept development, typically occurs between the identification of a technology or a business opportunity, such as a new product or service, and the development of actual communication and packaging materials. Conceptual design is both a term and a practice. Conceptual design is sometimes referred to as and encompasses the following disciplines: branding, creating brand identity, brand design, concept development, ideation and synectics.

Product manufacturers and service providers usually undertake conceptual design by assigning in-house employees to work on the conceptual design project based on their particular field of experience. Representative employees from marketing, sales, product development, packaging design and research departments are chosen to develop the conceptual design. Representatives of advertising agencies or other outside consultants are sometimes selected to supplement or facilitate the in-house group's efforts and provide creativity that may be lacking in the group.

The representative employees are typically people who have a high degree of familiarity, experience or expertise with the specific project, or closely related projects, that the final conceptual design will be used with. The conventional group typically works against a set of project parameters in a sequential manner. First, a definition of the product function and formulation is developed, followed by a period of months to years of development of packaging, graphics, versioning, emotional benefits, communication materials, display materials, Internet concepts and other marketing tools.

Consumer research is usually conducted throughout the process in which consumers are asked to assess individual elements of the conceptual design piece by piece (e.g., product benefits, names, packaging) at many different stages of the concept development. Only after many months have passed, at the end of the design process, are consumers exposed to the entire product concept, as they would experience it in a marketplace environment. The entire process can sometimes take years to complete, without one complete concept ever having been assembled and evaluated until the very last stages. Thus, significant time, money and manpower are spent developing individual ideas which are not combined for evaluation of their total effect until the conceptual development is essentially complete. There is no provision for evaluating the aggregate impact of the various facets of a complete idea in the current concept development process. synergy is a key component of in-market success.

One aspect of the invention involves the use of persons exhibiting different learning styles or intelligences. Diversity of intelligence refers to verbal and mathematical aptitudes, as well as about six other aptitudes. Verbal and mathematical aptitudes have long been valued above other types through standardized testing methods used by colleges and corporations to evaluate candidates. Recently, these other types of aptitudes have begun to be recognized by educators as discreet, recognizable intelligences which are present in all people in varying degrees. The greater one form of aptitude or intelligence is present greatly affects how that person perceives the world around them and how they analyze and resolve problems.

The forms of intelligence which are now being recognized include the traditional verbal and mathematical/logical intelligences, which are the aptitudes for using written and spoken language, and for using quantitative information in a logical manner. The more recently recognized intelligences include: 1) emotional or interpersonal intelligence—the aptitude for understanding relationships and interactions between people; 2) visual intelligence—the aptitude for conceiving and receiving ideas in a visual form; 3) musical intelligence—the aptitude for conceiving and receiving ideas as music or in an audio-textural form; 4) spatial intelligence—the aptitude for conceiving and receiving ideas in three dimensions; 5) worldly intelligence—an aptitude for sensing and discerning trends and patterns in the world; 6) physical intelligence—the aptitude for understanding and conceiving how physical entities interact; and 7) practical intelligence—an aptitude for pragmatic problem solving and implementation.

An article by Kathy Checkley entitled, “The First Seven . . . and the Eighth: A Conversation with Howard Gardner” from Educational Leadership, vol. 55, no. 1 published in Sep. 1997 discusses aspects of the different types of intelligence. Mr. Gardner is a psychologist and professor at Harvard University who has developed the theory of multiple intelligences.

Some prior art patents discuss different methods for evaluating personal thinking styles, such as U.S. Pat. No. 6,159,015, which discloses a method for profiling intelligence by temperament and preferences. In the background, the patent discusses personality temperaments and the Myers-Briggs test for evaluating preferences for solving problems as well as other classical method for classifying a person's thought processes. The profiling method disclosed involves evaluating both a person's temperament and their current preferences to establish a multi-dimensional view of how the person evaluates problems and interacts with others.

Methods for directing group projects are known as well, such as the method disclosed by U.S. Pat. No. 5,662,478 for a training facilitator to teach others to use an expeditionary process to generate ideas. The expeditionary process is intended to stimulate creative thinking in the trainees. The expeditionary process is represented by a map of a fictional trip through the creation process. The process includes forming a team, providing rules and goals in the form of a staged expedition and procedures for achieving the goals. The facilitator of the method attempts to mold the trainees to each think differently from different perspectives and to use particular rules for brainstorming. For example, in one region of a fictional map used for the “expedition” labeled, “the mess” , the facilitator may exhort the team to try different methods of thinking and various possible solutions to resolve the situation. The method of does not involve selecting trainees who innately possess diverse intellectual aptitudes, but rather encouraging each trainee to use different methods.

U.S. Pat. No. 5,989,034 teaches a hexagonal element association method and organizational form in which an initial element has up to six associated elements, each of which in turn has up to six sub-elements, and which can be further subdivided into additional groups of six elements. The elements can be graphically arranged in a hexagonal pattern to assist interpretation of the relationship between elements. The method provides a way to transform abstract ideas into concrete elements which are more easily understood.

A method for predicting the success of an employee is disclosed by U.S. Pat. No. 5,551,880. The method involves having the employee answer a series of questions and evaluating the response to arrive at a numeric value that defines characteristics of the employee and which can be further processed using predictive models to determine the likelihood the employee will be successful at a given task.

U.S. Pat. No. 5,970,482 teaches an artificial intelligence-powered data mining tool. The computerized tool is used to analyze complex data automatically to build models that can be used to predict behavior and to understand behaviors. The tool can be used in credit acceptance decisions, for example, or in design processes to develop a new product for a particular market. The tool uses computer programmed neuroagents to evaluate data and produce results for a user of the tool.

A graphical tool for quantifying desirability of a page location of an advertisement directed to consumers for a product is disclosed by U.S. Pat. No. 5,855,482. The page is divided into segments which are graphically represented by lines indicating division lines between regions. Each region is assigned a desirability level in terms of “profile units” from 0 to 100, with 100 indicating the most desirable location. Depending on the location of the page in a publication, among other factors, a graphical representation of the desirable advertising locations on the page can be created.

U.S. Pat, No. 6,038,537 describes a computerized commodity exchange system for use internally by an organization which includes a database of available commodities. A computer evaluates the parties to the commodity deal and determines the scope of the deal based on a variety of factors such as the level of association between the organization components. The system is particularly suited for aiding intra-organization cooperation to reduce costs and improve efficiency.

While these prior methods and tools provide utility in particular areas, they are not adaptable to remove deficiencies in current conceptual design processes to provide a more efficient and effective method for developing a conceptual design of a product or service.

Reliance on standardized tests, which promote verbal and mathematical aptitudes above all others, by corporations and universities has resulted in a significant underrepresentation of other types of intelligences and a homogenization of thinking styles in most large, organized workplaces. A lack of diversity in thought processes, skill sets and backgrounds of the workforce has the effect of limiting the ability of conventional conceptual design project teams to develop broad, innovative product and service marketing concepts which appeal to persons of all aptitudes. Further, the familiarity of conventional team members to their product or service further results in fewer fresh, innovative or new concepts being developed.

### SUMMARY OF THE INVENTION

It is an object of the present invention to provide a conceptual design method which facilitates the efficient development of a comprehensive and innovative conceptual design for a product or service.

It is a further object of the invention to provide a process for developing a conceptual design for a product or service having a deeper and broader communication to consumers.

Yet another object of the invention is to provide a conceptual design process incorporating ideas relating to diverse types of learning or intelligences.

A further object of the invention is to produce a conceptual design with greater synergy among the component idea elements, so that consumers are exposed to the synergy to provide greater appeal than designs created using conventional methods.

Accordingly, the process of the invention comprises a method of developing product marketing ideas by organizing at least one select group of people, who can be called thinkers, with intellectual strengths in disciplines that may be unrelated to the product, such as a color expert (her strength) with no expertise in hand lotions (the product). The thinkers generate and conceptualize many different concepts/themes/placements for the product under consideration. Each of the thinkers selected for the group uses a fundamentally different intelligence or thought process to process information, formulate ideas and analyze problems. The process seeks to take advantage of the inherently diverse approaches used by the different thinkers to produce a broader concept for positioning a product to provide deeper mental and emotional connections for a consumer to use to identify with the product. The process provides a method for simultaneously developing different facets of a nearly complete marketing idea for presentation to a client, rather than sequential development of the idea elements. At the same time, by generating many different ideas at once with diverse intelligences or thought processes, the conceptual design for a product or service can be developed more rapidly and more efficiently.

The method comprises the steps of identifying basic product or service information, identifying a team coordinator, the team coordinator selecting a team of thinkers each representing a different intelligence or analytical point of view, the team coordinator identifying and providing immersion stimuli relating to the product to the team of thinkers. Then, each member of the team generates ideas using their innate intelligence and expertise, which may be in fields unrelated to the product. The ideas are discussed and considered by the entire team to produce one or more multifaceted primary ideas for final conceptual design development. The multifaceted ideas generated by the process of the invention are presented to the client/product manufacturer and/or tested by consumer exposure for approval. The winning idea may then be completely developed by the client and used as the conceptual design to market the product or service.

The method of the invention results in greater innovation as a result of assembling a team which is chosen for their aptitudes or intelligences as opposed to their experience with a given product or service. The team members are not bound by the rigid mentality and conventional thinking, and past “rules of success”, which dominate conventional conceptual design processes. The variety and diversity of aptitude sets and backgrounds of the team members results in the creation of a conceptual design having greater freshness and depth, and broader appeal to consumers of the product or service.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a flow chart representation of the conceptual design process according to the invention;

FIG. 2 is a chart illustrating possible different factors for consideration during the fixed-fluid analysis step of the process of FIG. 1; and

FIG. 3 is a representation of the components of a multifaceted idea created using the process of the invention.

### DESCRIPTION OF THE PREFERRED EMBODIMENTS

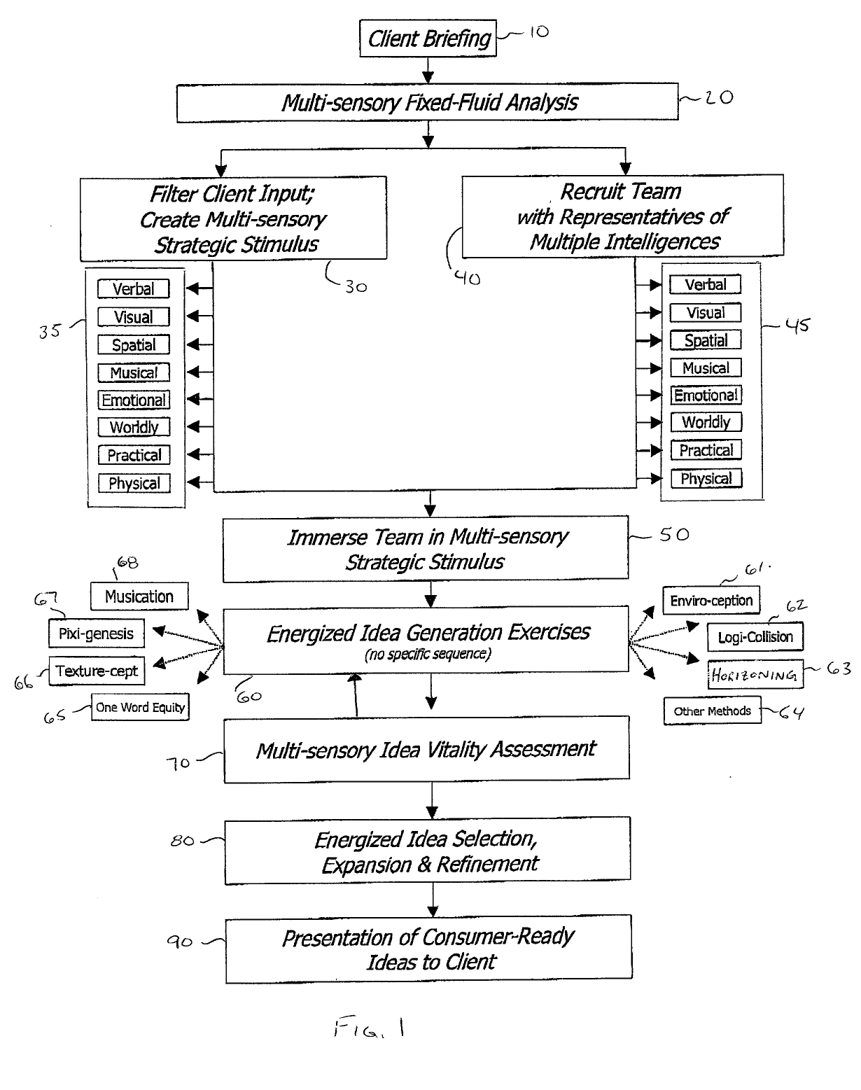

Referring now to the drawings, in which like reference numerals are used to refer to the same or similar elements, FIG. 1 illustrates the several steps in a preferred embodiment of the inventive conceptual design method. The illustrated process assumes that the conceptual design process will be handled by a supplier to the product manufacturer or service provider so that a client relationship is created between them.

First, the client product manufacturer or service provider and supplier conduct a client briefing 10 during which a project team leader, or team coordinator, is selected and basic product and project information are obtained.

The basic project and product information can include items such as the client/manufacturer, the client's brand, an identification of the product, the team coordinator's generalized preferred characteristics for each of the team members, critical dates in the product development cycle and budget information. The product or service identification is critical to the basic product information, as it forms the basis from which all other ideas in the conceptual design will flow from.

The team coordinator's first task is to perform a multi-sensory fixed-fluid analysis 20 of the project. The fixed-fluid analysis 20 helps prevent two key pitfalls to conceptual design which commonly occur in the initial stages. A lack of breadth in the definition of the project by producing an initial set of parameters and rules that limit idea generation or a lack of definition which permits very irrelevant results to be generated can both result in a failed concept design. The fixed-fluid analysis 20 requires the team coordinator to delineate the conceptual design project parameters based on whether a series of elements categorized based on the type of intelligence the element relates to is a fixed, pre-determined element or may be subject to development by the creative process.

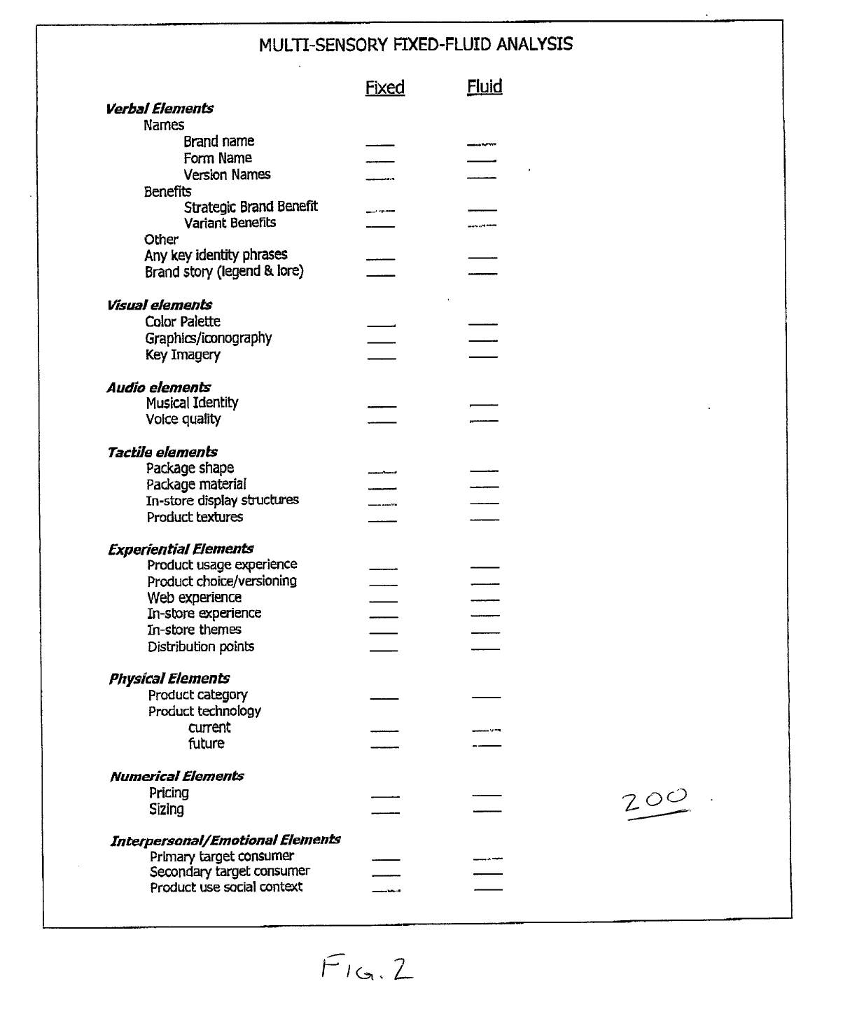

FIG. 2 illustrates one possible chart 200 that can be used for the fixed-fluid analysis. The team coordinator can check the column next to each element to indicate whether it is a predetermined (fixed) or variable (fluid) element that the project team must work with. Thus, under the “Verbal elements” heading, for an entirely new product, the names may all be fluid elements, while a new variation of an established product line may require that all but the version name are fixed. The team coordinator evaluates each feature using the fixed-fluid analysis to create the parameters for the conceptual design. The team coordinator may add or delete elements to the fixed-fluid analysis chart and categorize those elements as needed based on the understanding from the client briefing 10 of what the conceptual design for the client's product or service requires.

The team coordinator is then responsible for evaluating the results of the client briefing 10 and the fixed-fluid analysis 20 to select and create multi-sensory strategic stimuli 30. The multi-sensory stimuli should be representative of eight types of intelligence 35 which are generally preferred: verbal, visual, spatial, emotional, musical, worldly, physical and practical. The stimuli can include words, pictures, shapes, textures, experiences, sensations, sounds and smells, each of which is intended to relate a facet of the client's product to the eventual project team. For example, the stimuli may include a perfume fragrance, a cloth swatch of a particular color, a video or movie, or a poem, among other things. The stimuli are selected to spark creativity in different people in different ways to give them ideas that will relate to the client's product or services. The stimuli are used to provide some initial guidance to the project team and to keep the creativity focused on relevant ideas, without the team feeling bound by specific rules for the concept development.

The team coordinator also oversees selection 40 of the team members, or thinkers, in part by identifying characteristics of people representing each type of intelligence 45 that will be on the team. It is important to note that the team members are selected based on their area of aptitude or style of thinking, as opposed to their specific area of expertise. In most cases, expertise or pre-existing knowledge of the project, client or product type is avoided to prevent biases to existing thoughts and prevent the appearance of an imbalance or hierarchy in the representation of aptitudes. Typically, this means that traditional conceptual development team members such as the client's marketing, sales, product development people or other employees will not be included on the team. In the event that the team coordinator sees the development of a hierarchy during the conceptual design process, it may be appropriate or necessary to isolate certain team members at times to avoid them dominating the design process and obtain their input separately. The remaining team members must be kept informed and made to understand that the reason for the isolation is done to maintain the non-hierarchal environment and ensure that one member's ideas do not overly influence or direct the ideas generated by the team.

The team coordinator locates and recruits people having the characteristics and greater aptitude to be thinkers on the team and represent each desired type of intelligence 45. There are eight types of intelligence 45 which are generally preferred: verbal, visual, spatial, emotional, musical, worldly, physical and practical. Persons who are representative of two other types of intelligence, mathematical and logical, are not as preferred as their aptitudes are typically more useful in the evaluation of ideas than in the creation of ideas.

Individuals representing each intelligence can be identified through a database or network of consultants or independent contractors, or via professional services. The people being recruited are screened based on a number of criteria, including professional accomplishment that may indicate a particular intelligence or aptitude, referrals and recommendations and by in-person exploration of their capabilities by the team coordinator. For example, professional accomplishments might include a popular work of art, indicating visual intelligence or starting a charitable group by organizing and motivating other people, indicating emotional/interpersonal intelligence.

In a preferred aspect of the method, the team coordinator may represent practical intelligence on the team. The team members representing each remaining type of intelligence are selected and recruited 40 for the product marketing project.

The stimuli selection 30 and team selection 40 may be done concurrently or one after the other. The total number of stimuli or team members selected is dependent upon the team coordinator's decisions, and possibly, on the client's budget. Thus, as few as one stimulus and one additional team member could be selected. However, it is preferable that between about 4-8 stimuli are selected and about 4-8 team members are selected, so that a majority of the different intelligences are represented in each case.

Once the team is created 40 and stimuli have been selected 30, the generation of ideas and formulation of concepts by the team members begins in earnest. The team members are given the stimuli selected by the team coordinator to immerse 50 the team in the project. The team members experience each of the stimuli and begin to think of ideas and concepts that can be used with the client's products or services based in part on the particular intelligence of the individual team member, or thinker.

Immersion 50 in the selected stimuli serves the purpose of providing both filtration of core concepts by the team coordinator for consideration by the team and relevant inspiration for the team. Lack of filtration and lack of inspiration are problems which are overcome by this step. Lack of filtration occurs when the team members are presented with an excess amount of information, some of which is relevant and some which is not, thereby creating confusion within the team. Lack of inspiration is simply the result of too much filtration, so that core ideas are presented as over-simplified numbers and words. The immersion stimuli provided to the team members in the immersion 50 step avoid both problems by providing a variety of inspiration to different types of thinkers using information (the stimuli) which has been filtered by the team leader in the prior steps.

The team coordinator then provides additional guidance by organizing at least one idea generation session 60 during which one or more energized idea exercises 61-68 are done by the team. The energized idea exercises 61-68 include disruptive thinking exercises; exercises involving substituting, rearranging and reversing regimens, systems and patterns to find new uses or benefits; and exercises to adapt, modify, magnify and minimize ideas.

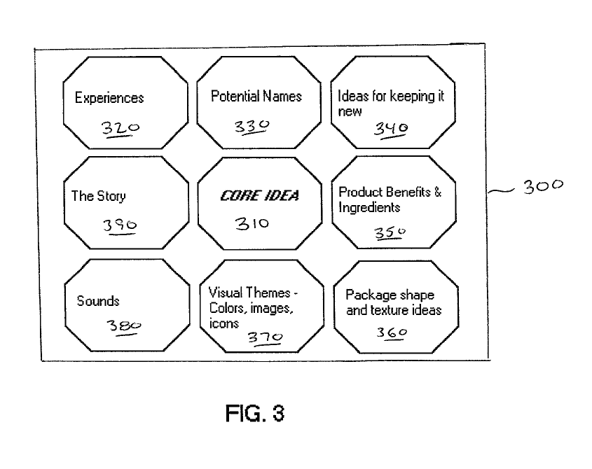

The purpose of the idea generation session 60 is to produce one or more energized ideas 300, generally having the components shown in FIG. 3. Each energized idea 300 has a core idea 310 around which all of the other facets 320-390 are related. The additional facets 320-390 are the aspects of the idea which make it interesting and exciting to a wide range of consumers and which provide different ways for consumers to relate to the presentation of the product or service embodied in the core idea 310. Facets of the energized idea 300 which are preferred include experiences 320, potential names 330, a story path for keeping the idea fresh 340, identification of product benefits and ingredients 350, packaging colors, shapes and textures 360, the visual identity for the product 370, sounds associated with the product 380 and a story 390 for the product explaining its origins or helping to relate all of the other facets together.

The facets of the energized ideas 300 can include about eleven different elements, including the “essence” of the product, names, benefits and formulations, visual identity for the product, tactile identity (includes packaging shapes, textures and icons), an audio springboard of musical themes and attitudes, versioning, experiential identity such as key affiliations or causes, in-store themes, a brand story and a news path for refreshing the idea over time. The energized idea 300 presents an expression of the product that allows consumers to assess each of the concepts generated by the team as a single, integrated proposition to provide a better presentation of the product to the consumer than individual marketing elements used in conventional strategies. Presenting the energized idea 300 to consumers for evaluation provides more realistic consumer responses than those received from element by element exposure used in conventional design testing procedures.

The energized ideas 300 may be considered multi-faceted, multi-sensory concepts. The ideas 300 provide a whole concept for a product, where all or most of the elements relating to the client's product or service are considered and generated concurrently at the outset of the concept creation. Traditionally, the facets would be generated sequentially, one after the other. Each facet of the energized idea 300 may not be fully complete at this point of the process, but the basis for the facet is at least provided.

Referring again to FIG. 1, the energized idea exercises can include MUSICATION 68, where an energized idea 300 is developed based on audio or musical stimuli alone; PIXIGENESIS 67, in which the energized idea 300 is developed using only visual stimuli and ONE WORD EQUITIES 65, which uses single words or simple phrases to develop the energized idea 300. The other exercises include TEXTURE-CEPT 66, using tactile stimuli, ENVIRO-CEPTION 61 relating experiences to the energized idea 300, LOGI-COLLISION 62, where logical concepts are violated to produce the energized idea 300 and HORIZONING 63, involving looking forward in time and projecting a path for keeping the idea fresh over time. Other thinking exercises 64 can also be used to cause S the thinkers in the team to use the stimuli in combination with their aptitude to develop energized ideas 300. The trademarks used to identify each of the idea exercises above are owned by Saatchi & Saatchi of New York, N.Y.

The particular exercises 61-68 that are used in a given project will depend on the client's product or service, and not all exercises need to be used on all projects. The team coordinator is responsible for disrupting the exercises 61-68 and changing to a different exercise to avoid excessive time spent in one direction, resulting in loss of creativity by bogging down in the idea, and to keep the group interest and stimulation at a high level.

Once at least one energized idea 300 is generated by the team, the facets of the idea 300 are evaluated by the team members during a multi-sensory idea vitality assessment 70. All of the facets in the idea 300 are evaluated for their ability to produce points of difference in the marketplace across a range of consumers representing different forms of intelligence. That is, the facets are evaluated for their appeal to each of the identified forms of intelligence and their ability to effectively present the core idea to the consumer. Ideas 300 or facets that fail to appeal to a majority of different intelligences are given back to the team for further development or discarded.

The idea generation exercises and assessment 70 can be repeated as many times as necessary until a multifaceted energized idea 300 is created which the team evaluates as having a wide appeal to various intelligences.

Once a multifaceted energized idea 300 is accepted by the team, the idea is expanded and refined 80 as needed to complete all facets 320-390 of the idea 300. If more than one idea 300 has passed the assessment stage 70, then the team must also select a reasonable number of ideas for expansion and refinement 80. For example, the team may choose to select three ideas to refine for presentation 90 to the client. The client can then select which of the concepts embodied in the energized ideas it prefers for use in promoting its product or service.

A first advantage of the idea creation and development process of the invention is that at least one market-ready concept is presented to the client at the end of the process. The concepts can be generated more rapidly as well using the process because of the concurrent idea facet generation, as opposed to traditional sequential development processes, where each piece is approved piecemeal until the final idea is eventually completed. The inventive process provides the entire product concept up-front and ready to go when the client first sees it.

A second advantage of the process is that the concepts are not developed in the vacuum of one piece at a time. The concurrent development of the facets provides better real-world results because the facets have a greater degree of interconnection and relation.

The multiple facets of the energized ideas give the concept broader appeal and deeper connections for the consumer to make with the product or services.

The process allows for the rapid development of several, whole concepts in a much shorter period of time. The energized ideas can be presented 90 to the client for approval, followed by almost immediate consumer testing, as opposed to lengthy additional development, and implementation in the marketplace. Used properly, the inventive process can reduce the time to generate and implement product concepts from many months or years using traditional methods to as short as a few weeks. In the current economy, the ability to develop and implement an effective marketing concept in shorter and shorter periods is essential, as consumer tastes and preferences change faster and faster.

The following are provided as examples of how the method can be used to develop a product concept.

### EXAMPLE 1

The client is a pet food manufacturer and supplier. The client meets with the person who will be the team coordinator. During the meeting, the client indicates that it has developed a new dog food which is all-natural, has been shown to improve dogs overall health, and the client wants to sell the product at a significant premium as part of its WONDER line of pet foods. The primary target market for the dog food is owners of highly trained or pedigreed dogs taken to shows, but the client would like to be able to sell to other dog owners who care about their dog's health. A client brief is assembled containing the information, as well as the target product launch date of 8 months from the meeting, and budget information.

The team coordinator then begins to consider the likely of the team members and conducts a fixed-characteristics fluid analysis of the project. The coordinator notes that the client wants to use its WONDER trademark, so the naming is somewhat restricted. Further, the visual and audio features of the WONDER trademark that should not be changed and those that can be variable are defined as well. The pricing information is also fixed by the client, but not the package size. Some of the physical elements of the product, such as the category—pet food—and the technology are also fixed. The remaining fixed-fluid analysis is concluded, and the team coordinator begins working on selecting immersion stimuli and team members. For the stimuli (intelligence they relate to in parenthesis), the team coordinator selects and prepares a tape recording of dogs barking (audio/music), a video of several dogs engaged in various activities such as playing catch with a frisbee in a park (visual), a dog food bowl (emotional), a book on dogs and their care (text), a sheaf of color samples of vibrant, bright colors (visual), a sample of the dog food (tactile) and a dog show program (experiential). The team coordinator begins choosing team members drawn from diverse backgrounds and demonstrating distinct types of intelligence (indicated in parenthesis). The team coordinator selects a team consisting of: 1) a pet photographer (visual); 2) an animal trainer (verbal) ; 3) a user of a seeing-eye dog (spatial); 4) a dog show judge (worldly); 5) an 11-year old boy who owns a dog (emotional); 6) a veterinarian (physical); 7) a pet store owner (practical).

The team members are selected and organized, and given the immersion stimuli with a description of the project by the team coordinator. The team meets regularly over several weeks to conduct energized idea generation exercises and facets of four energized ideas are developed by the team members, each using their particular view of the product to shape the facets and overall concept of each energized idea.

The four energized ideas are each brought the assessment stage and evaluated for their appeal. Two energized ideas are discarded as not being broad enough, while two are selected for expansion and refinement. The two remaining energized ideas are refined to complete concepts for the dog food and subsequently presented to the dog food manufacturer, who selects one of the concepts for consumer testing and to implement as the marketing strategy.

### EXAMPLE 2

A cosmetics manufacturer develops an entirely new line of skin care products that it wants to create a unique brand name and marketing strategy to promote and sell the skin care product. At the client briefing, the team coordinator is selected and gathers the following information for the basic product information. The skin care products contain aloe and a unique emulsifier with good moisturizing properties. The client would like to begin selling their skin care product in one year through retail outlets which currently carry their makeup products at a mid-level price point. The client does not want to associate the skin care line with the makeup in the event that one of the business lines can be sold. Budget information is provided. The team coordinator begins to develop a list of characteristics of a user of the product for use in selecting team members.

The team coordinator performs the fixed-fluid analysis, noting that nearly all of the categories except for the product category and price are open for development by the team.

The team coordinator then starts selecting the immersion stimuli (related intelligence in parenthesis) for the product, including women's beauty magazines (emotional), samples of the lotion (experiential), white and green color samples (visual), an aloe plant (spatial, experiential), tropical music recordings (musical) and a handbook of cosmetics compounds (verbal/textual).

Team members are selected fitting the following types of people: 1) a dermatologist (physical); 2) a fashion trend analyst (visual); 3) sisters (emotional); 4) a health spa designer or operator (spatial); 5) a musician (musical); 6) a housewife (worldly) and 7) a beauty tip writer (verbal). The team coordinator represents practical intelligence on the team.

The project team is then assembled and given a project briefing, followed by the immersion stimuli. The team meets several times in a period of weeks and develops facets for ten ideas, of which three eventually are assessed as worthy of expansion and refinement for presentation to the client. The three successful energized ideas are presented as viable concepts to the client for selection of which to use to market the new skin care product.

### EXAMPLE 3

A retail store with stagnant sales wants to develop a new conceptual design to help it sell more of its products and expand to take advantage of the Internet for advertising and sales to consumers. The store owners meet with the team coordinator and provide the basic project and product information to the team coordinator. The information includes the name of the store, a current store layout, a list of its products available for sale, its present color scheme and its present marketing concepts it is unhappy with. The team coordinator is also provided with a time line for implementing the new conceptual design idea that will be generated and a budget.

The team coordinator does the fixed fluid analysis, noting which aspects of its current image the retail store owners are willing to change and which must remain fixed.

The team coordinator begins selecting creative individuals based on their aptitudes and intelligence strengths. The team coordinator wants to ensure that multiple intelligences are represented in the concept design group. The team coordinator must also consider that the team members have a common level of category understanding to avoid creating or developing a hierarchy of team members during the conceptual design process.

The team coordinator selects people having the following characteristics and intelligences: 1) a web site writer/designer (verbal); 2) a portrait photographer (visual); 3) a flow or traffic analyst (spatial) ; 4) a drummer (musical); 5) a marriage counselor (emotional); 6) a color trend analyst (worldly); 7) a closet organizer (practical); and 8) a mime (physical).

The team is assembled and the idea generation process begins the first day with immersion in multi-sensory stimuli that have been preselected by the team coordinator. The stimuli include: 1) a written presentation outlining the project objectives; 2) textiles, fabrics and color swatches; 3) charts and graphs outlining sales trends; 4) photographs of the client's retail store environment (interior and exterior); 5) a video tape interview of shoppers exiting the store about their experience shopping; and 6) a scent associated with the store permeating the meeting room, via candle, perfume, incense, etc. The team members are exposed to each of the stimuli and as ideas are generated, the team coordinator clusters the ideas and keeps a record for the team. Additional brainstorming is based off the initially generated ideas.

The team may use brainstorming tools to assist them, such as CONCEPTUAL WALLPAPER or DECORE-ATION brainstorming process tools (trademarks of Saatchi &, Saatchi). CONCEPTUAL WALLPAPER involves defining loose areas on the walls or white boards in different areas of the meeting room, and having team members combine ideas by walking around the room and taking inspiration from others. DECORE-ATION is a process where the team members identify the core element of the brand, category, service or product, eliminate it, and then define a new purpose for the remaining elements.

At the end of the first group session, a homework assignment is given to the team members to stimulate the multiple intelligences represented. Each team member will be responsible for presenting a report to the rest of the team at the next group meeting. The assignment may be selected by the team members or assigned randomly. Possible assignments include sending one or more members to a variety of environments and instructing them to note similarities, differences and other people's interaction with the environment. The purpose of this assignment is to begin a dialogue on the unique properties of different spaces and locations. A second assignment involves collecting shopping bags from different stores and bring them to the next meeting to lead a discussion of what each bag communicates about the store it came from and the products sold there, among other information. The third possible assignment is to have team members assemble a scrap book using a disposable camera, markers, fabrics, paper based on a topic, such as “costumes and masquerades” for the retail store client. The scrap book should provide multiple examples of the topic in a variety of forms using the materials. A fourth assignment is to send team members to a wine tasting or a coffee bar or another place where particularly engaging foods or drinks are found to create a character or personality around each drink or food they sample.

At the second group session, held within 1-2 weeks of the first meeting, the group first shares the results of their homework assignments. Again, the team coordinator keeps track of ideas as they are generated and moderates discussions as the team members build on the ideas from the first meeting and develop new ones from the homework assignments. The group can then be divided into smaller teams to conduct more ideation assignments which build off of the existing ideas and use filtered stimuli from the homework or other sources selected by the team coordinator.

The ideation assignments include Saatchi & Saatchi's LOGI-COLLISION, TEXTURE-CEPT, and ONE WORD EQUITIES brainstorming techniques. The LOGI-COLLISION technique takes divergent ideas from the group sessions and has the team create a new concept or idea. The TEXTURE-CEPT process provides textures to the team to have them use the texture as the basis for adding depth to one of the group ideas. Using the ONE WORD EQUITIES technique, the small teams create a brand based on one or more preselected single words or short phrases given to them by the team coordinator. Another technique is to have one team create products for different target audience segments. The audience can be divided like in high school, with jocks, cheerleaders, nerds, shop kids, chess club, band members, etc. or along different lines. The different intelligences represented in the group should result in several, diverse ideas being generated. The new ideas generated using these techniques are collected and presented at the end of the group session, and the team members are given a new homework assignment for the third session.

The second homework assignments are designed to take full advantage of the different intelligences of the group by giving each group member an assignment most closely related to their intelligence or aptitude. Each team member is given their tailored assignment selected by the team coordinator and instructed to choose between 1-4 ideas they are most passionate about and develop their assignment from those ideas. The team members will be expected to present and defend the results of their assignments at the next group session. In the case of the retail store client, the assignments are as follows

| Team Member | |
|---|---|
| (Intelligence) | Assignment |
| Web site writer | write a parable about a shopping |
| (Verbal) | journey |
| Photographer | create a collage of territory, |
| (Visual) | products & shoppers |
| Traffic Analyst | bring materials that create a |
| (Spatial) | tangible brand world |
| Marriage | plan for how will employees be |
| Counselor | trained in customer service |
| (Emotional) | |
| Drummer | create or bring musical examples |
| (Musical) | that create a shopping experience |
| Closet | create a marketing plan (based on |
| Organizer | example/template given to member) |
| (Practical) | |
| Mime (Physical) | walk through existing store and |
| | develop mime routines to present |
| | recommended changes for enhancing |
| | the shopping experience |
| Color Trend | identify three key shopper |
| Analyst | targets and cultural or home |
| (Worldly) | furnishing trends that the store |
| | can use to appeal to each target |
| | audience |

The final session begins with each group members presentation of their homework assignment. The presentations are videotaped to reinforce the idea that the presentations matter and for later reference. After the presentations, the team coordinator identifies any new ideas that were developed and the group begins the final round of generating energized ideas from those that were presented. The team members can be assigned to groups and use the same or new brainstorming techniques to expand the ideas from the presentations. The session ends with a group discussion of the best facets and ideas generated and a selection of the ideas for presentation to the client. The best energized, multi-faceted conceptual designs selected by the group are then presented to the client for final development, testing and use. A new conceptual design is thus created for the client in as few as three weeks.

While a specific embodiment of the invention has been shown and described in detail to illustrate the application of the principles of the invention, it will be understood that the invention may be embodied otherwise without departing from such principles.

What is claimed is:

1. A method for generating creative ideas for marketing and advertising a product or service, the method comprising:
selecting a team coordinator;
defining the scope of a conceptual design using a fixed-fluid analysis;
selecting at least one immersion stimulus, each stimulus relating to the product or service and corresponding to an intelligence selected from one of verbal, visual, spatial, musical, emotional, worldly, practical, physical, logical and mathematical;
selecting at least one team member having an aptitude representative of one of the intelligences;
conducting an immersion session by exposing each team member to the at least one immersion stimulus; and
conducting energized idea generation exercises with the team members to produce an energized idea having a plurality of facets, each relating to the product or service, wherein the energized idea is capable of being implemented as a complete conceptual design for the product or service.

2. A method according to claim 1, further comprising assessing the energized idea produced by conducting energized idea exercises by the team coordinator and at least one team member to evaluate the appeal of the energized idea to each one of verbal, visual, spatial, musical, emotional, worldly, practical, and physical intelligences.

3. A method according to claim 2, further comprising rejecting the energized idea if the evaluation of the appeal is not positive for a majority of the intelligences and accepting the energized idea if the evaluation of the appeal is positive for a majority of the intelligences.

4. A method according to claim 1, wherein the defining the scope, selecting at least one immersion stimulus and selecting at least one team member are done by the team coordinator.

5. A method according to claim 4, wherein the team coordinator selects at least five team members, each team member having an aptitude representative of a different one of the intelligences.

6. A method according to claim 5, wherein the team coordinator selects at least five immersion stimuli, each stimulus relating to a different one of the intelligences.

7. A method according to claim 1, wherein selecting at least one immersion stimulus comprises selecting at least five stimuli, each stimulus relating to a different one of the intelligences.

8. A method according to claim 1, wherein selecting at least one team member comprises selecting at least five team members, each team member having an aptitude representing a different one of the intelligences.

9. A method according to claim 1, wherein the aptitude of the at least one team member is not directly related to the product or service.

10. A method according to claim 1, wherein a time period between selecting the team coordinator and producing an energized idea is less than six months.

11. A method according to claim 10, wherein the time period is less than two months.

12. A method for generating creative ideas for marketing and advertising a product or service, the method comprising:
defining the scope of a conceptual design for the product or service;
selecting at least four immersion stimuli, each is stimulus relating to the product or service and corresponding to a different one of an intelligence selected from one of verbal, visual, spatial, musical, emotional, worldly, practical, physical, logical and mathematical;
selecting at least four team members, each team member having an aptitude representative of a different one of the intelligences;
exposing each team member to each immersion stimulus;
conducting energized idea generation exercises with the team members to produce an energized idea having a plurality of facets, each relating to the product or service, the energized idea being capable of being implemented as a complete conceptual design for the product or service; and
assessing the energized idea by evaluating the appeal of the energized idea to each of the intelligences.

13. A method according to claim 12, further comprising selecting a team coordinator for defining the scope, selecting the at least four immersion stimuli and selecting the at least four team members.

14. A method according to claim 12, wherein assessing the energized idea further comprises repeating conducting energized idea generation exercises to revise energized ideas that are evaluated as having negative appeal, followed by reassessing the revised energized ideas.

15. A method according to claim 12, wherein the aptitudes of the at least four team members are not directly related to the product or service.

16. A method according to claim 12, wherein a time period between defining the scope and producing an energized idea is less than six months.

17. A method according to claim 16, wherein the time period is less than two months.

18. A method of generating creative ideas, the method comprising:
identifying a subject for creating a conceptual design;
defining the scope of the conceptual design;
selecting at least one immersion stimulus, each stimulus relating to the subject and corresponding to a different one of an intelligence selected from one of verbal, visual, spatial, musical, emotional, worldly, practical, physical, logical and mathematical;
selecting at least two team members, each team member having an aptitude representative of a different one of the intelligences;
exposing each team member to each immersion stimulus; and
conducting energized idea generation exercises with the team members to produce an energized idea having a plurality of facets, each relating to the product or service, the energized idea being capable of being implemented as a complete conceptual design for the product or service.

19. A method according to claim 18, wherein one of the team members is a team coordinator, the team coordinator selecting the at least one immersion stimulus and selecting the remaining ones of the at least two team members.

20. A method according to claim 18, wherein a time period between defining the scope and producing an energized idea is less than six months.

21. A method according to claim 20, wherein the time period is less than two months.

22. A method according to claim 21, wherein conducting energized idea exercises comprises holding at least two meetings with the team members over a period of between four to six weeks, the team members performing energized idea exercises at each meeting.

23. A method according to claim 18, wherein conducting energized idea exercises comprises holding at least two meetings with the team members over a period of between four to six weeks, the team members performing energized idea exercises at each meeting.

24. A idea generation method for a group led by a team coordinator to rapidly generate multi-faceted creative ideas having a broad appeal for a conceptual design, the method comprising:
the team coordinator defining the scope of the conceptual design;
assembling the group by the team coordinator, the group representing at least three different intelligences;
selecting at least three immersion stimuli by the team coordinator, each stimuli corresponding to a different intelligence;
conducting group meetings led by the team coordinator;
performing energized idea exercises at the group meetings using the at least three immersion stimuli;
generating an energized idea having a plurality of facets, each facet relating to a core idea of the conceptual design, the energized idea being capable of being implemented as a complete conceptual design.

25. The method of claim 24, wherein the intelligences represented in the group and immersion stimuli are selected from verbal, visual, spatial, musical, emotional, worldly, practical, physical, logical and mathematical.

26. The method of claim 25, wherein a time period between defining the scope and generating an energized idea is less than six months.

27. The method of claim 24, wherein a time period between defining the scope and generating an energized idea is less than six months.

28. The method of claim 27, wherein the time period is less than two months.

29. The method of claim 28, wherein conducting group meetings comprises conducting at least three group meetings.

30. The method of claim 24, wherein conducting group meetings comprises conducting at least three group meetings.
